(19) United States
(12) Patent Application Publication
(10) Pub. No.: US 2026/0235106 A1
(43) Pub. Date: Aug. 13, 2026

(54) ELECTRICITY GENERATING DEVICE

(71) Applicant: Raymond Bohning, Fort Pierce, FL (US)

(72) Inventor: Raymond Bohning, Fort Pierce, FL (US)

(21) Appl. No.: 19/052,920

(22) Filed: Feb. 13, 2025

(51) Int. Cl. F03D 9/00; F03D 3/00; F03D 9/11; F03D 9/25; H02K 7/116; H02K 7/18; H02K 11/00; H02K 11/05; H02S 10/12; H02S 10/20

(52) U.S. Cl. CPC F03D 9/007; F03D 3/005; F03D 9/11; F03D 9/25; H02K 7/116; H02K 7/183; H02K 11/0094; H02K 11/05; H02S 10/12; H02S 10/20; F05B 2220/706; F05B 2220/708; F05B 2240/211; F05B 2260/42

(57) ABSTRACT

An electricity generating device for generating electricity simultaneously from solar and wind sources includes a base and a turbine rotatably mounted to the base. The turbine comprises a shaft and a plurality of cups coupled to and radially arranged around the shaft. Each cup defines a cavity bounded by an interior surface of the cup. Each cup also has a rim which defines an opening to the cavity. The openings of the cups of the plurality of cups face in a first rotational direction around the shaft. Each cup has an exterior surface opposite the interior surface which widens from a base end of the cup to the rim of the cup. Each one of a plurality of solar panels is mounted on the exterior surface of an associated cup of the plurality of cups. A generator is operatively coupled to the shaft.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### g) BACKGROUND OF THE INVENTION

### (1) Field of the Invention

The disclosure relates to electricity generation devices and more particularly pertains to a new electricity generation device for generating electricity simultaneously from solar and wind sources.

### (2) Description of Related Art including information disclosed under 37 CFR 1.97 and 1.98.

The prior art discloses electricity generation devices which convert light and wind power into electricity, including devices in which vanes used to rotate a turbine via the wind include solar panels for generating electricity from solar rays. However, the prior art fails to describe such an apparatus which uses dome-shaped cups to rotate such a turbine and solar panels which mount to and are conformed to the shape of exterior surfaces of the cups.

### (h) BRIEF SUMMARY OF THE INVENTION

An embodiment of the disclosure meets the needs presented above by generally comprising a base and a turbine rotatably mounted to the base. The turbine comprises a shaft and a plurality of cups coupled to and radially arranged around the shaft. Each cup defines a cavity bounded by an interior surface of the cup. Each cup also has a rim which defines an opening to the cavity. The openings of the cups of the plurality of cups face in a first rotational direction around the shaft. Each cup has an exterior surface opposite the interior surface which widens from a base end of the cup to the rim of the cup. Each one of a plurality of solar panels is mounted on the exterior surface of an associated cup of the plurality of cups. A generator is operatively coupled to the shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an electricity generating device according to an embodiment of the disclosure.

FIG. 2 is a front view of an embodiment of the disclosure.

FIG. 3 is a cross-section view of an embodiment of the disclosure taken from Line 3-3 in FIG. 2.

FIG. 4 is an in-use view of an embodiment of the disclosure.

### (J) DETAILED DESCRIPTION OF THE INVENTION

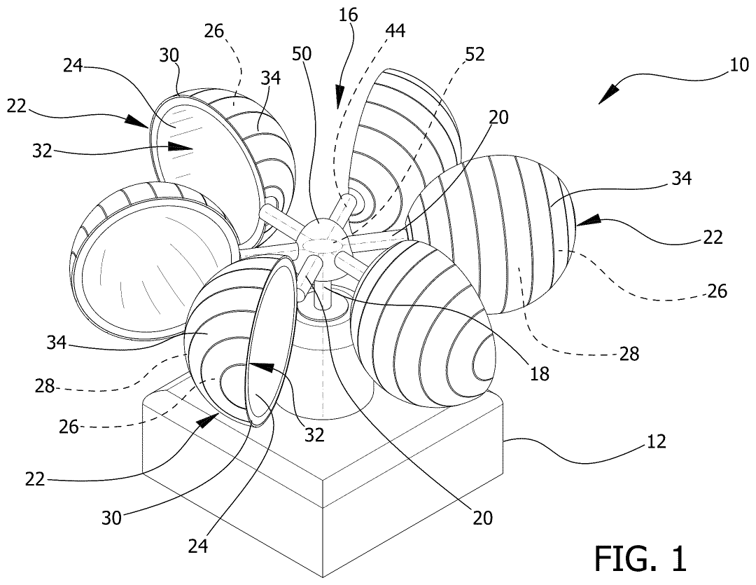

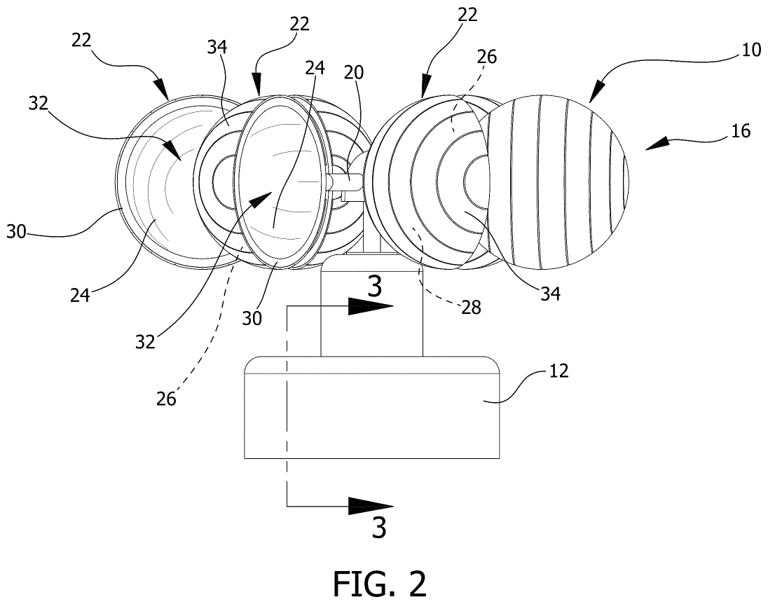

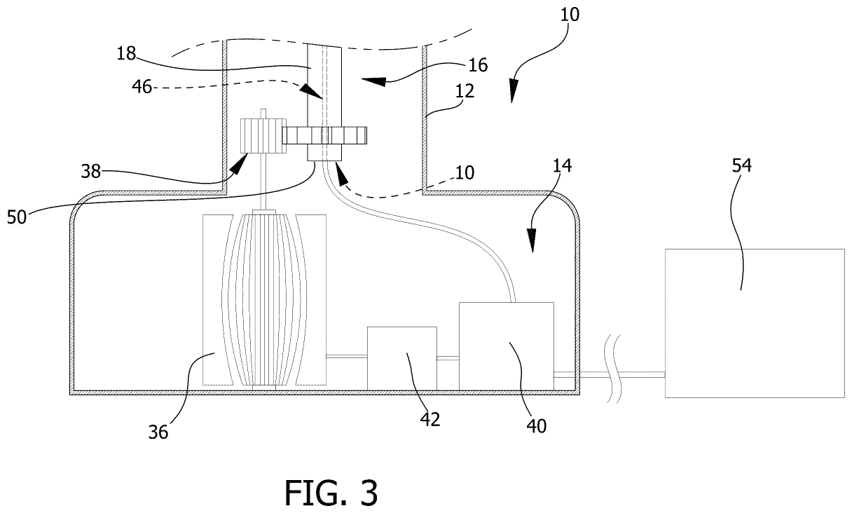

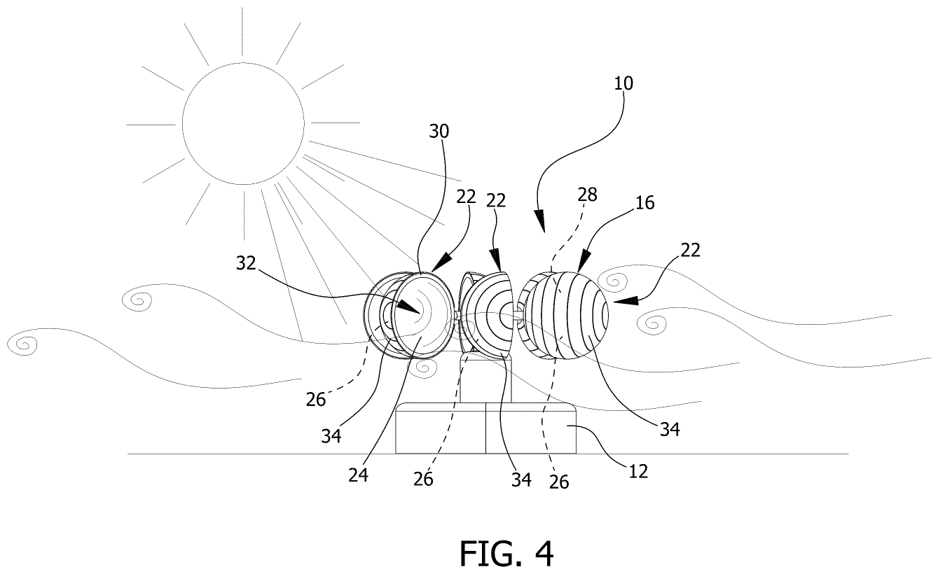

With reference now to the drawings, and in particular to FIGS. 1 through 5 thereof, a new electricity generation device embodying the principles and concepts of an embodiment of the disclosure and generally designated by the reference numeral 10 will be described.

As best illustrated in FIGS. 1 through 5, the electricity generating device 10 generally comprises a base 12 which defines an interior volume 14 therein. A turbine 16 is rotatably mounted to the base 12. The turbine 16 comprises a shaft 18 and a plurality of cups 22 coupled to and radially arranged around the shaft 18. A plurality of spokes 20 couple the plurality of cups 22 to the shaft 18, wherein each spoke 20 is coupled to and extends between the shaft 18 and an associated cup 22 of the plurality of cups 22. The cups 22 are therefore spaced outwardly away from the shaft 18. The spokes 20 are equal in length to each other, and the cups 22 are equal in size and shape to each other. However, in other embodiments, the spokes 20 may have varying lengths and the cups 22 may have varying sizes and shapes.

Each cup 22 defines a cavity 32 bounded by an interior surface 24 of the cup 22 and has a rim 30 which defines an opening to the cavity 32. The openings of the cups 22 face in a first rotational direction around the shaft 18. Each cup 22 has an exterior surface 26 opposite the interior surface 24 which widens from a base end 28 of the cup 22 to the rim 30 of the cup 22. Each cup 22 has a dome shape but may have other suitable shapes such as a cone, a conical frustrum, a pyramid, a pyramidal frustrum, or the like. Shapes such as cylinders or rectangular prisms may be less aerodynamic than other alternatives but may be used for the cups 22 in some embodiments.

The turbine 16 further includes a plurality of solar panels 34, each of which is mounted on the exterior surface 26 of an associated cup 22 of the plurality of cups 22. Each solar panel 34 conforms in shape to the exterior surface 26 of the associated cup 22.

The shaft 18 of the turbine 16 drives a generator 36 mounted in the interior volume 14 of the base 12. The shaft 18 is operatively coupled to the generator 36 via a geartrain 38 or other power transfer mechanism. An energy storage 40 comprising a battery is mounted in the interior volume 14 of the base 12 and is electrically coupled to the generator 36. A power inverter 42 is electrically coupled to and serially between the generator 36 and the energy storage 40. The power inverter 42 is configured to convert alternating electrical current produced from the generator 36 into direct electrical current for charging the energy storage 40.

Solar charging wiring 44 is electrically coupled to and extends between the plurality of solar panels 34 and the energy storage 40. The solar charging wiring 44 extends through an interior space 46 within the shaft 18 of the turbine 16 and extends out of the interior space 46 of the shaft 18 through an aperture 48 formed at one end 50 of a pair of ends 50 of the shaft 18 toward the energy storage 40. A slip ring 52 or similar mechanism is coupled with the solar charging wiring 44 such that electricity generated by the solar panels 34 rotating with respect to the base 12 may be transmitted to the energy storage 40 which is stationary with respect to the base 12.

In some embodiments, the energy storage 40 may include a flywheel energy storage device, a hydraulic accumulator, a capacitor, or any other device for storing energy. Devices for storing energy may be placed outside of the base 12. Suitable energy converting devices may also be included to convert between different forms of energy when using such energy storage devices.

In use, the cups 22 are shaped such that wind flows more readily past the exterior surfaces 26 of the cups 22 than around the rims 30 of the cups 22. As such, when the wind blows against the cups 22, the cups 22 are urged to rotate the shaft 18 in a second rotational direction opposite the first rotational direction due to the wind applying a greater force against the interior surfaces 24 of the cups 22 than the force the wind applies against the exterior surfaces 26. The resulting rotation of the shaft 18 operates the generator 36 to produce electricity which is stored in the energy storage 40.

Simultaneously or at other times, the solar panels 34 may generate electricity via exposure to sufficient light for storage in the energy storage 40. The energy storage 40 may then electrically couple to an extrinsic battery 54 or other load to charge or power the same. Additional control circuits or processors may be used to control the charging of the energy storage 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electricity generating device comprising:
a base;
a turbine rotatably mounted to the base, the turbine comprising:
a shaft;
a plurality of cups coupled to the shaft, the plurality of cups being radially arranged around the shaft, each cup of the plurality of cups defining a cavity bounded by an interior surface of the cup, each cup of the plurality of cups having a rim defining an opening to the cavity, the openings of the cups of the plurality of cups facing in a first rotational direction around the shaft, each cup of the plurality of cups having an exterior surface opposite the interior surface, the exterior surface of each cup widening from a base end of the cup to the rim of the cup; and
a plurality of solar panels, each solar panel of the plurality of solar panels being mounted on the exterior surface of an associated cup of the plurality of cups; and
a generator operatively coupled to the shaft.

2. The electricity generating device of claim 1, wherein each cup of the plurality of cups has a dome shape.

3. The electricity generating device of claim 1, wherein the turbine further comprises a plurality of spokes, each spoke being coupled to and extending between an associated cup of the plurality of cups and the shaft such that each cup of the plurality of cups is spaced outwardly from the shaft.

4. The electricity generating device of claim 1, wherein each solar panel of the plurality of solar panels conforms in shape to the exterior surface of the associated cup.

5. The electricity generating device of claim 1, further comprising a geartrain operatively coupling the shaft to the generator.

6. The electricity generating device of claim 1, further comprising an energy storage electrically coupled to the generator and the plurality of solar panels.

7. The electricity generating device of claim 6, wherein the energy storage comprises a battery.

8. The electricity generating device of claim 6, further comprising solar charging wiring which is electrically coupled to and extends between the plurality of solar panels and the energy storage, the solar charging wiring extending through an interior space within the shaft of the turbine, the solar charging wiring extending out of the interior space of the shaft through an aperture formed at one end of a pair of ends of the shaft.

9. The electricity generating device of claim 6, further comprising a power inverter electrically coupled to the generator and the energy storage, the power inverter being configured to convert alternating electrical current produced by the generator into direct electrical current for charging the energy storage.

10. An electricity generating device comprising:
a base, the base defining an interior volume therein;
a turbine rotatably mounted to the base, the turbine comprising:
a shaft;
a plurality of cups coupled to the shaft, the plurality of cups being radially arranged around the shaft, each cup of the plurality of cups defining a cavity bounded by an interior surface of the cup, each cup of the plurality of cups having a rim defining an opening to the cavity, the openings of the cups of the plurality of cups facing in a first rotational direction around the shaft, each cup of the plurality of cups having an exterior surface opposite the interior surface, the exterior surface of each cup widening from a base end of the cup to the rim of the cup, each cup of the plurality of cups having a dome shape, the plurality of cups being spaced outwardly from the shaft;
a plurality of solar panels, each solar panel of the plurality of solar panels being mounted on the exterior surface of an associated cup of the plurality of cups, each solar panel of the plurality of solar panels conforming in shape to the exterior surface of the associated cup; and
a plurality of spokes, each spoke being coupled to and extending between an associated cup of the plurality of cups and the shaft;
a generator operatively coupled to the shaft, the generator mounted in the interior volume of the base;
a geartrain operatively coupling the shaft to the generator;
an energy storage electrically coupled to the generator and the plurality of solar panels, the energy storage comprising a battery;
solar charging wiring electrically coupled to and extending between the plurality of solar panels and the energy storage, the solar charging wiring extending through an interior space within the shaft of the turbine, the solar charging wiring extending out of the interior space of the shaft through an aperture formed at one end of a pair of ends of the shaft; and
a power inverter electrically coupled to the generator and the energy storage, the power inverter being configured to convert alternating electrical current produced by the generator into direct electrical current for charging the energy storage.
